(19) United States
(12) Patent Application Publication
(10) Pub. No.: US 2001/0019966 A1
(43) Pub. Date: Sep. 6, 2001

(54) Remote, central monitoring system for game machines

(76) Inventor: Mitsuhira Idaka, Tokyo (JP)

Correspondence Address: SUGHRUE, MION, ZINN, MACPEAK & SEAS, PPLC, 2100 Pennsylvania Avenue, N.W., Washington, DC, 20037, US

(21) Appl. No.: 09/797,799

(22) Filed: Mar. 5, 2001

(30) Foreign Application Priority Data
Mar. 3, 2000 (JP) P2000-058492

(51) Int. Cl. G06F 17/00

(52) U.S. Cl. 463/40

(57) ABSTRACT

Game machines (1) are located in a plurality of places. Each of the game machines (1) is provided with a monitoring control unit (2) for incorporating the situation-of-use information including payment-object-insertion detected number information of payment-object-insertion detector (5) and for sending it to a common central monitoring apparatus (3). The central monitoring apparatus (3) is able to centrally monitor the situation of the use of each of the game machines (1) based on the situation-of-use information received from each of the game machines (1). When the game machines (1) are rental game machines, the number of plays of each of the game machines (1) can be obtained based on the payment-objectinsertion detected number information, and the rental fee for each of the game machines (1) according to the number of plays can be calculated and collected.

### BACKGROUND OF THE INVENTION

1. Field of the Invention

The present invention relates to a remote, central monitoring system for centrally monitoring a plurality of game machines which are located in a plurality of places.

The present application is based on Japanese Patent Application No. 2000-058492, which is incorporated herein by reference.

2. Description of the Related Art

Rental fees for game machines to nationwide game centers are charged, for example, according to the number of games played (number of game plays) in game machines. For example, in a coin-inserting-type game machine in which a game is started by inserting a coin, a sales staff visits the place where a game machine is installed with the key of a coin box of the game machine. The sales staff then opens the coin box with the key and checks the number of coins within the coin box, i.e., checks the number of game plays performed by inserting coins so as to calculate a rental fee according to the number of game plays. The sales staff then collects the calculated rental fee.

The game machine is equipped with a coin-insertion detector for detecting the insertion of coins. Thus, a sales staff who visits the installation place of the game machine may check the number of game plays by counting the number of coin insertions detected by the coin-insertion detector rather than by the number of coins in the coin box. Thus, the sales staff is able to calculate a rental fee according to the number of game plays and collect the calculated rental fee.

As discussed above, in order to collect the rental fees for the game machines, a sales staff has to go through the trouble of visiting the various installation places of the game machines. This increases travelling expenses and personnel expenses for the sales staff, thereby hampering profit-making.

It is also difficult to precisely determine the situation of the use for the rented game machines. For example, it is difficult to prevent the illegal use of game machines, which is discussed below.

One example of the illegal uses of the game machines is the use of a free switch. The free switch is a switch enabling a game to be started without inserting a coin. For example, while a game player is playing a game, the game may be accidentally terminated due to an accident which is not the player's fault (for example, a power failure). Or, even though a coin is inserted, the game machine may fail to detect the insertion of the coin for some reason, thereby failing to start the game. Or, the person in charge may test a game for maintenance. In these cases, the above-described free switch is used for starting the game.

The number of game plays performed by turning on the free switch is not reflected in the number of coins or the number of coin insertions detected by the coin-insertion detector. Accordingly, the game plays performed by turning on the free switch are not included in the rental fee even though, in reality, the game was played, thereby effectively reducing the rental fee.

As discussed above, it is difficult to precisely monitor the situation of the use for the game machines, which makes it very difficult to find the illegal use of game machines by using the free switch.

### SUMMARY OF THE INVENTION

The present invention has been made to solve the above-described problem. Accordingly, it is an object of the present invention to provide a remote, central monitoring system for game machines, in which the situations of the use for many game machines installed in a plurality of places can be centrally monitored, and the automatic collection of rental fees and the prevention of the illegal uses of the game machines can be achieved.

To achieve the above object, according to a first aspect of the present invention, there is provided a remote, central monitoring system for remotely and centrally monitoring a plurality of game machines, which comprises a common central monitoring apparatus; and

a plurality of game machines located in a plurality of places, the plurality of game machines being remotely and centrally monitored by the common central monitoring apparatus,

wherein each of the plurality of game machines is capable of starting a game by inserting a payment object, and comprises:

a payment-object-insertion detector which detects insertion of a payment object,

a payment-object counter which counts the number of times insertion of a payment object is detected,

a free switch which starts the game without inserting a payment object,

a situation-of-use information incorporating device which incorporates predetermined situation-of-use information of each of the game machines, the situation-of-use information including at least one of payment-object-insertion detected number information of the payment-object-insertion detector of the game machine, count value information of the payment-object counter, switching-on information of the free switch, and power on/off information of each of the game machine,

a data storage device which stores the incorporated situation-of-use information, and

a communication device which sends the information stored in the data storage device to the common central monitoring apparatus.

According to a second aspect of the present invention, preferably, the communication device according to the first aspect sends the information stored in the data storage device to the common central monitoring apparatus by wireless communication.

According to a third aspect of the present invention, preferably, the communication device according to the second aspect sends the information stored in the data storage device to the common central monitoring apparatus by using a wireless communication system for cellular telephones.

According to a fourth aspect of the present invention, preferably, each of the game machines according to any one of the first, second, and third aspects comprises a timepiece mechanism, and at least the power on/off information of each of the game machines is incorporated as the situation-of-use information of the game machine, and wherein at least the power on/off information among the situation-of-use information of the game machine is stored in the data storage device by being associated with time information of the timepiece mechanism and is sent to the common central monitoring apparatus.

According to a fifth aspect of the present invention, preferably, each of the game machines according to any one of the first to fourth aspects comprises a timepiece mechanism, a one day period is divided into a plurality of predetermined time slots by utilizing the timepiece mechanism, and a data writing unit which writes the situation-of-use information of the game machine for each of the time slots into the data storage device, and wherein the situation-of-use information of each of the game machines for each of the time slots is sent from each of the game machines to the common central monitoring apparatus.

A sixth aspect of the present invention comprises the configuration according to the fifth aspect. According to the sixth aspect, preferably, the common central monitoring apparatus comprises a display device which displays the situation of the use of the game machine based on the situation-of-use information for each of the time slots received from the game machine.

A seventh aspect of the present invention comprises the configuration according to any one of the first to sixth aspects. According to the seventh aspect, preferably, at least the switching-on information of the free switch is sent from each of the game machines to the central monitoring apparatus as the situation-of-use information of the game machine, and wherein the common central monitoring apparatus comprises a warning issuing unit which issues a warning when the illegal use of the game machine based on the switching-on information of the free switch received from the game machine is detected.

An eighth aspect of the present invention comprises the configuration according to any one of the first to seventh aspects. In the eighth aspect of the present invention, each of the game machines may be used as a rental game machine. At least the payment-object-insertion detected number information of the payment-object-insertion detector is sent from each of the game machines to the common central monitoring apparatus as the situation-of-use information of the game machine, and wherein the central monitoring apparatus comprises: a rental-fee detecting unit which automatically determines a rental fee of the game machine based on the received payment-object-insertion detected number information of the payment-object-insertion detector; and an automatic bill issuing unit which automatically issues a bill for the rental fee.

A ninth aspect of the present invention comprises the configuration according to the eighth aspect. According to the ninth aspect, preferably, the common central monitoring apparatus comprises an automatic-bill-deduction processing unit which automatically performs processing for the automatic deduction of the rental fee of the game machine determined by the rental-fee detecting unit from a predetermined banking system.

A tenth aspect of the present invention comprises the configuration according to any one of the first to ninth aspects. According to the tenth aspect, preferably, at least the situation-of-use information incorporating device, the data storage device, and the communication device are provided separately from each of bodies of the game machines as a monitoring control unit via a signal connection device, and serve as the situation-of-use information incorporating device, the data storage device, and the communication device provided for each of the game machines, respectively, and wherein the situation-of-use information of each of the game machines is sent to the common central monitoring apparatus via the monitoring control unit.

In the present invention constructed as described above, it should be noted that the present invention is applicable to any game machines that utilize a payment object used as compensation which is necessary for players to play (or start) the games. For example, the payment object includes money, such as a coin, a paper currency, a bank note, a bank bill, etc., and other objects, such as a token, a medal, etc.

In the present invention constructed as described above, for example, the situation-of-use information incorporating device of the game machine incorporates the predetermined situation-of-use information of the game machine. The incorporated situation-of-use information is stored in the data storage device, and the communication device sends the stored situation-of-use information to the central monitoring apparatus.

In the central monitoring apparatus, the number of game plays in each of the game machines can be obtained based on the situation-of-use information of the game machine, for example, the payment-object-insertion detected number information of the payment-object-insertion detector, received from the game machine.

Details of the situation of the use of the game machines located in a plurality of places can be monitored without going through the trouble of visiting the installation places of the game machines. For example, the illegal use of the game machines can be detected based on the switching-on information of a free switch sent from the game machines to the central monitoring apparatus. Additionally, the situation of the use of the game machines can be checked based on the situation-of-use information so that various new aspects can be introduced, such as giving advice about the setting of use environments, such as the degree of difficulty of the game.

### BRIEF DESCRIPTION OF THE DRAWINGS

FIG. 1 schematically illustrates an embodiment of a remote, central monitoring system for game machines according to the present invention;

FIG. 2 is a block diagram illustrating the major configuration of a game machine according to the individual embodiments;

FIG. 3 is a block diagram illustrating the major configuration of a central monitoring apparatus according to the individual embodiments;

FIG. 4 schematically illustrates the storage status of the situation-of-use information stored in a data storage device of the game machine according to the individual embodiments; and

FIGS. 5A, 5B, and 5C illustrate other embodiments.

### DETAILED DESCRIPTION OF THE PREFERRED EMBODIMENTS

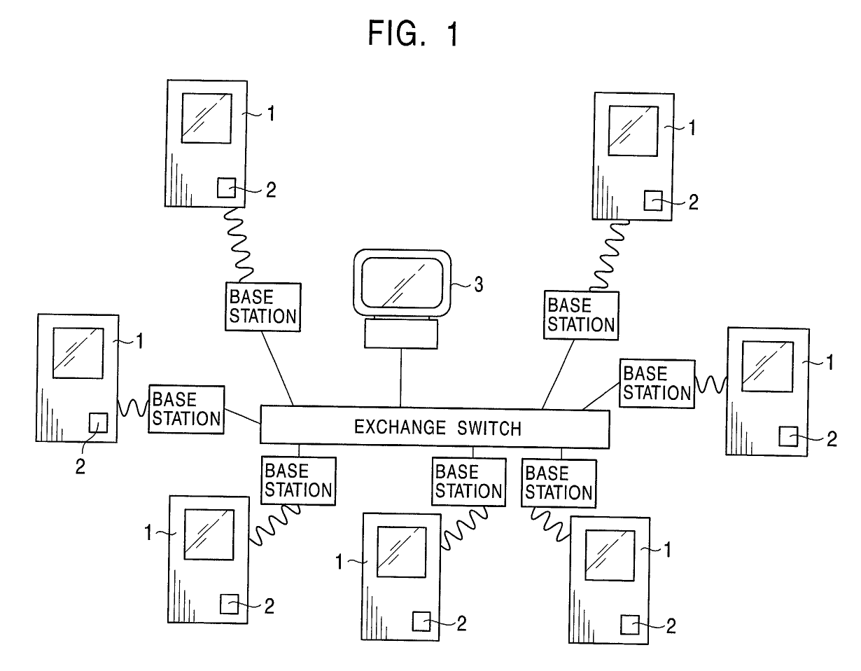

Preferred embodiments of the present invention now will be described hereinbelow with reference to FIGS. 1 to 5C.

FIG. 1 schematically illustrates a remote, central monitoring system for game machines according to a first embodiment. In the first embodiment, as shown in FIG. 1, a monitoring control unit 2, which is discussed below, is built into each of a plurality of game machines 1 rented in various locations nationwide, and the individual game machines 1 are connected to a common central monitoring apparatus 3 by utilizing a communication network for cellular telephones, such as a PDC (Personal Digital Cellular telecommunication system) or a PHS (Personal Handyphone System). With this arrangement, a remote, central monitoring system for game machines is constructed.

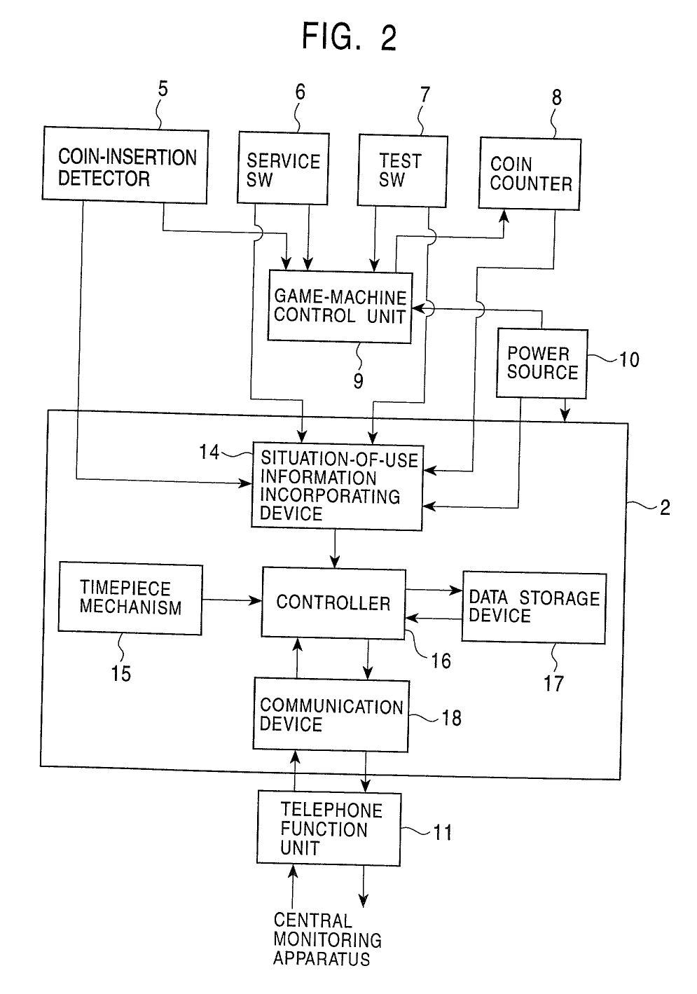

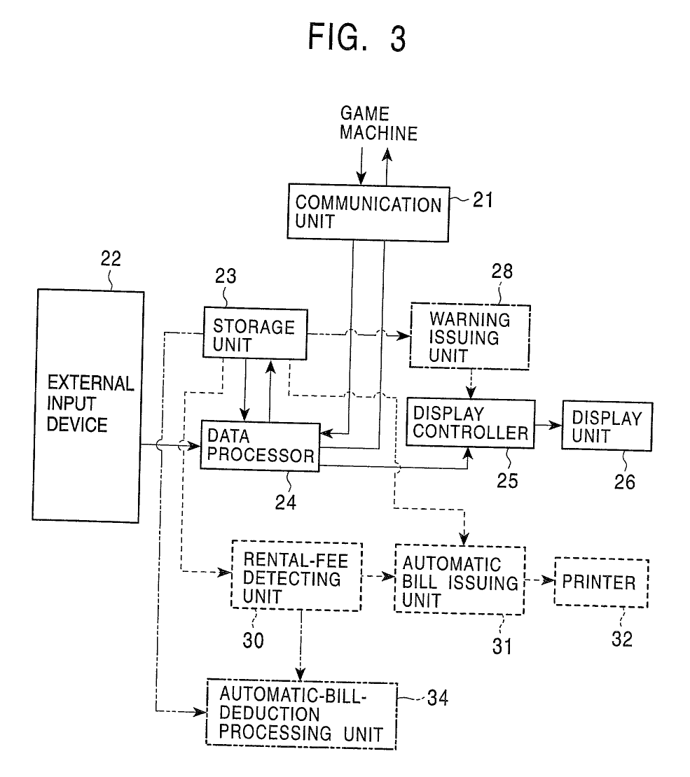

FIG. 2 is a block diagram illustrating the major configuration of each game machine 1 having the above-described built-in monitoring control unit 2 according to the first embodiment. FIG. 3 is a block diagram illustrating the major configuration of the central monitoring apparatus 3 indicated by solid blocks according to the first embodiment.

In the first embodiment, the game machine 1 includes, as shown in FIG. 2, a coin-insertion detector 5, a service switch (service SW) 6, a test switch (test SW) 7, a coin counter 8, a game-machine control unit 9, a power source 10, and a telephone function unit 11. As discussed above, the monitoring control unit 2 is built into the game machine 1. The monitoring control unit 2 is formed of a situation-of-use information incorporating device 14, a timepiece mechanism 15, a controller 16, a data storage device 17, and a communication device 18.

In the first embodiment, the central monitoring apparatus 3 is formed of, as indicated by the solid blocks in FIG. 3, a communication unit 21, an external input device 22, a storage unit 23, a data processor 24, a display controller 25, and a display unit 26.

The coin-insertion detector 5 of the game machine 1 shown in FIG. 2 detects the insertion of a coin from a coin slot (not shown), and counts the number of coin insertions by using, for example, a counter.

The service SW 6 is one type of free switch. It is used for starting a game on occasions such as when the game is terminated due to an accident which is not the player's fault (for example, a power failure) while the player is playing the game, or when the game does not start because the game machine fails to detect the insertion of a coin performed by the player for some reason. The test SW 7 is also one type of free switch. When testing the game for maintenance, the person in charge turns on the test SW 7 to start the game without inserting a coin.

Upon receiving a signal transmitted from the controller of the game-machine control unit 9, which is discussed below, based on the detection of the insertion of a coin by the coin-insertion detector 5, the coin counter (electromagnetic counter) 8 increments, that is, counts the number of coin insertions detected by the game-machine control unit 9.

The power source 10 is connected to, for example, a commercial power source. When power is supplied from the commercial power source by turning on a power switch (not shown), the power source 10 supplies the power to predetermined elements, such as the game-machine control unit 9 and the monitoring control unit 2.

The game-machine control unit 9 is provided with a controller (not shown), which controls various control operations of the game machine 1. For example, when it is determined that power has been received from the power source 10 and also that the insertion of a coin has been detected by the coin-insertion detector 5, the controller allows the coin counter 8 to increment, and starts and controls the game according to a predetermined program for controlling the game.

Additionally, when it is detected that the service SW 6 or the test SW 7 has been turned on, the above-described controller starts the game regardless of whether or not a coin has been inserted, or controls the setting of use environments, such as the degree of difficulty of the game.

The situation-of-use information incorporating device 14 provided for the monitoring control unit 2 incorporates the predetermined situation-of-use information of the game machine 1, and supplies it to the controller 16. The above-mentioned situation-of-use information of the game machine 1 is information about the situation of the use of the game machine 1, and in the first embodiment, includes at least information concerning the number of coin insertions detected by the coin-insertion detector 5 (coin-insertion detected number information), information concerning the switching of the service SW 6 and the test SW 7 (switching-on information), both of which are free switches, information concerning the count values of the coin counter 8 (count-value information), and the on/off information of the power source 10.

The above-described controller 16 stores the situation-of-use information of the game machine 1 incorporated via the situation-of-use information incorporating device 14 in the data storage device 17 by using the timepiece mechanism 15, or sends the situation-of-use information to the central monitoring apparatus 3 by controlling the operation of the communication device 18. As discussed above, in the first embodiment, the controller 16 serves as a data writing unit for writing the situation-of-use information of the game machine 1 into the data storage device 17.

An example of the control operations performed by the controller 16 is as follows. The controller 16 divides the one day period into a plurality of predetermined time slots, and incorporates the situation-of-use information of the game machine 1 for each time slot and stores it in the data storage device 17. Various techniques are available for incorporating the above-described information (data) for each time slot. Any technique may be employed in this embodiment, one specific example of such a technique is discussed below.

The controller 16 is provided with a service SW counter (not shown), a test SW counter (not shown), and a power source counter (not shown). Based on the information incorporated via the situation-of-use information incorporating device 14, the controller 16 detects the number of times the service SW 6 and the test SW 7 have been switched on and the number of times the power source 10 is switched on/off for each time slot by utilizing the above-described counters and the timepiece mechanism 15, and then stores the detected numbers in the data storage device 17 as the switching-on information of the service SW 6, the switching-on information of the service SW 7, and the power on/off information, respectively.

The controller 16 also detects, for example, the time each time slot ends, the number of coin insertions detected by the coin-insertion detector 5 and the count value of the coin counter 8 via the situation-of-use information incorporating device 14 by utilizing the timepiece mechanism 15. The controller 16 then stores the detected number of coin insertions and the count value in the data storage device 17, and also reads the previous number of coin insertions detected by the coin-insertion detector 5 and the previous count value of the coin counter 8 from the data storage device 17. Then, the controller 16 subtracts the previous number of coin insertions from the current number of coin insertions so as to determine the amount by which the number of coin insertions detected by the coin-insertion detector 5 for the corresponding time slot has been increased. The controller 16 also subtracts the previous count value counted by the coin counter 8 from the current count value so as to determine the amount by which the count value of the coin counter 8 for the corresponding time slot has been increased. The determined values are then stored in the data storage device 17 as the information concerning the number of coin insertions detected by the coin-insertion detector 5 (coin-insertion detected number information) and the information concerning the count value of the coin counter 8 (count value information).

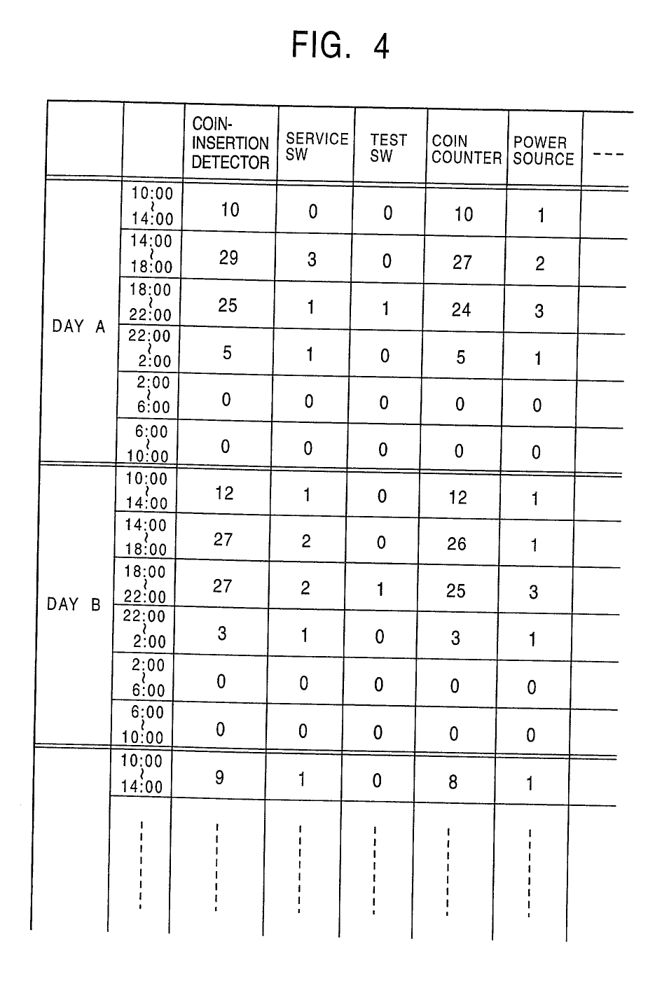

As discussed above, the controller 16, which serves as a data writing unit, stores the situation-of-use information of the game machine 1 for each time slot including the coin-insertion detected value information of the coin-insertion detector 5, the switching-on information of the service SW 6 the test SW 7, the power on/off information, and the count value information of the coin counter 8 in the data storage device 17. An example of the storage status of the situation-ofuse information is shown in FIG. 4.

The controller 16 reads the situation-of-use information accumulated in the data storage device 17 at predetermined time intervals (for example, every day, every week, or every month) by utilizing the timepiece mechanism 15, and relates the read situation-of-use information with predetermined ID information unique to each game machine. The controller 16 then outputs the situation-of-use information and the ID information to the communication device 18. The communication device 18 converts the situation-of-use information and the ID information into a communication signal, and outputs it to the telephone function unit 11 of the game machine 1.

The telephone function unit 11 transmits the signal received from the communication device 18 to the central monitoring apparatus 3. In the first embodiment, the telephone function unit 11 transmits the received signal to the central monitoring apparatus 3 by radio according to a wireless communication system for cellular telephones. There are various wireless communication systems for cellular telephones. Any system can be employed in this embodiment, and an explanation thereof is omitted.

Upon receiving an instruction to send the situation-of-use information from the central monitoring apparatus 3 via the telephone function unit 11 and the communication device 18, the controller 16 reads the requested situation-of-use information of the game machine 1 from the data storage device 17, and relates the ID information unique to the game machine 1 to the situation-of-use information, as stated above. The controller 16 then outputs the situation-of-use information and the ID Information to the central monitoring apparatus 3 via the communication device 18 and the telephone function unit 11.

Upon receiving the signal output from the game machine 1, as stated above, the communication unit 21 of the central monitoring apparatus 3 shown in FIG. 3 extracts the situation-of-use information and the ID Information of the game machine 1 from the received signal, and outputs them to the data processor 24. The data processor 24 stores the situation-of-use information and the ID information in the storage unit 23.

When detecting that a user of the central monitoring apparatus 3 externally inputs an instruction to display the situation-of-use information of the game machine 1 by using the external input device 22, such as a keyboard or a mouse, the data processor 24 reads the requested situation-of-use information of the game machine 1 from the storage unit 23, and outputs it to the display controller 25.

Upon receiving the above-described situation-of-use information, the display controller 25 displays it on the display unit 26 in a preset display mode (for example, the mode shown in FIG. 4). In the first embodiment, the display controller 25 and the display unit 26 form a display device for displaying the situation of the use of the game machine 1. Instead of displaying the situation-of-use information of the game machine 1 on the display unit 26, a printer 32 may be used for printing out the situation-of-use information. Thus, any suitable technique may be used for obtaining the situation-of-use information of the game machine 1.

According to the first embodiment, the situation-of-use information is transmitted by radio from the game machines 1 installed in various places nationwide to the common central monitoring apparatus 3 according to a wireless communication system for cellular telephones. It is thus possible to centrally monitor the situation of the use of the game machines 1 by using the central monitoring apparatus 3 without the need for visiting the installation places of the game machines 1. Accordingly, the number of game plays of each game machine 1 performed by inserting coins can be checked without the need for visiting the installation places based on the coin-insertion detected number information of the coin-insertion detector 5 and the count value information of the coin counter 8, both of which are contained in the situation-of-use information. In this manner, the rental fee for each game machine 1 can be collected. Thus, travelling expenses of the sales staff can be reduced, and profit is increased accordingly.

There are special circumstances for the game machines 1. For example, the installation places of the game machines 1 may be changed in the same game center every two or three days, or the game machines 1 may be frequently transferred between different game centers. Thus, in order to collect the situation-of-use information of the game machines 1 by cable communication, it is necessary to connect a cable to the game machines 1 every time they are moved. In the first embodiment, however, the situation-of-use information of the game machines 1 is collected by utilizing a wireless communication system for cellular telephones, thereby obviating the need for connecting a cable to the game machines 1, which is required for performing cable communication. Thus, the situation-of-use information of the game machines 1 can be collected without reducing the operability, which would otherwise be caused by the movement of the game machines 1.

Additionally, in the first embodiment, the switching-on information of each of the service SW 6 and the test SW 7 is transmitted as the situation-of-use information by radio from each game machine 1 to the central monitoring apparatus 3. It is thus possible to detect the illegal use of the game machine 1 by using the service SW 6 or the test SW 7, the above-described free switches. For example, the upper limit of the number of times the service SW 6 or the test SW 7 is switched on for performing maintenance or setting game environments can be preset. If the number of times the service SW 6 or the test SW 7 is switched on is far greater than the upper limit, it can be concluded that the game machine 1 is illegally used by using the service SW 6 or the test SW 7.

If it is detected that the game machine 1 is being illegally used, a warning may be issued to the person renting the game machine 1. Further, by informing such persons that the illegal use of the game machine 1 can be detected, it is expected that the illegal use of the game machine 1 can be prevented.

In the first embodiment, the timepiece mechanism 15 is also provided, and by utilizing the timepiece mechanism 15, the one day period is divided into a plurality of time slots, and the situation of the use of the game machine 1 can be divided according to the time slots. Thus, it is easy to obtain how the situation of the use of the game machine 1 changes over time during one day.

Moreover, in the first embodiment, the situation-of-use information incorporating device 14, the timepiece mechanism 15, the controller 16, the data storage device 17, and the communication device 18 are integrated into the monitoring control unit 2. Accordingly, the monitoring control unit 2 can be easily attached to the game machine 1 later. For example, the monitoring control unit 2 can be integrated into the already rented game machine 1, thereby establishing the above-described remote, central monitoring system. It is then possible to acquire the situation-of-use information of the game machine 1.

In the first embodiment, the monitoring control unit 2 and the game-machine control unit 9 are separately provided. Thus, it is possible to replace only one of the monitoring control unit 2 and the game-machine control unit 9 with a new one for repair or upgrading.

It is also possible to detect the power on/off information as the situation-of-use information of the game machine 1, thereby enabling the monitoring of the driving time of the game machine 1. For example, if the power of the game machine 1 has been off for a long period, it can be concluded that the game machine 1 may have broken down. Then, a service technician can be dispatched to repair the game machine 1, thereby improving service.

A second embodiment is discussed below. In the second embodiment, a warning issuing unit 28, indicated by the one-dot-chain block shown in FIG. 3, is provided for the central monitoring apparatus 3 of the first embodiment. In the second embodiment, the same elements as those of the first embodiment are designated with like reference numerals, and an explanation thereof will thus be omitted.

The warning issuing unit 28 automatically detects the above-described illegal use of the game machine 1 and issues a warning based on the switching-on information of the service SW 6 or the test SW 7 contained in the situation-of-use information sent by radio from the game machine 1 to the central monitoring apparatus 3. Various configurations may be considered for the warning issuing unit 28. Any configuration may be employed in this embodiment, and an example of such configurations is discussed below.

For example, a timepiece mechanism (not shown) is provided for the central monitoring apparatus 3. By utilizing the timepiece mechanism, the warning issuing unit 28 determines, at regular intervals, the total number of times the service SW 6 or the test SW 7 has been switched on since the game machine 1 was rented based on the switching-on information of at least one of the service SW 6 and the test SW 7. Then, the warning issuing unit 28 reads a preset warning number (for example, 100) stored in the storage unit 23, and compares it with the total number of times the service SW 6 or the test SW 7 has been switched on. Upon comparison, if the warning issuing unit 28 determines that the total number of times the service SW 6 or the test SW 7 has been switched on has reached the preset warning number, it issues a warning signal.

The warning signal is output to, for example, the display controller 25. The display controller 25 then displays a message warning issued against the illegal use of the game on the display unit 26 in a predetermined display mode. Alternatively, a message indicating that the illegal use of the game has been detected may be printed out by using the printer 32. In this manner, various techniques are available for reporting the illegal use of the game. Any technique may be employed in this embodiment, and an explanation thereof will be thus omitted.

According to the second embodiment, based on the switching-on information of the service SW 6 or the test SW 7 sent from each game machine 1 by radio, the illegal use of the game is automatically detected so as to issue a warning. It is thus possible to easily detect the illegal use of the game machine 1 without the need for manually analyzing the situation-of-use information sent from each game machine 1. This facilitates the prevention of the illegal use of the game machine 1.

A third embodiment is discussed below. In the third embodiment, a rental-fee detecting unit 30 and an automatic bill issuing unit 31, indicated by the broken-line blocks shown in FIG. 3, are provided for the central monitoring apparatus 3 of the first and second embodiments in order to automatically charge the rental fee of the game machine 1. In the third embodiment, the same elements as those of the first and second embodiments are designated with like reference numerals, and an explanation thereof will thus be omitted.

For example, the central monitoring apparatus 3 is provided with a timepiece mechanism (not shown). By utilizing the timepiece mechanism, the rental-fee detecting unit 30 reads the coin-insertion detected number information of the coin-insertion detector 5 of the game machine 1 (and also maybe the count value information of the coin counter 8) from the storage unit 23 at regular intervals (for example, a designated day every month). Based on this information, the rental-fee detecting unit 30 detects the number of coins inserted within a predetermined period (for example, one month from the first day to the last day of every month).

Then, based on the detected number of coins, the rental-fee detecting unit 30 calculates the rental fee for the game machine 1. An automatic detection method for the rental fee may be as follows. A mathematical equation for determining the rental fee using the number of coins as a parameter may be prestored in the storage unit 23, and the detected number of coins may be substituted into the parameter, thereby calculating the rental fee. Alternatively, a table or a graph correlating the number of coins with the rental fees may be prestored in the storage unit 23, and the rental fee may be calculated based on the table or the graph and the detected number of coins.

The rental-fee detecting unit 30 relates the rental fee detected as described above to the ID information unique to the game machine 1, and sends them to the automatic bill issuing unit 31.

The automatic bill issuing unit 31 automatically issues a bill based on the information received from the rental-fee detecting unit 30. For example, upon detecting that the rental fee and the ID Information of the corresponding game machine 1 have been received from the rental-fee detecting unit 30, the automatic bill issuing unit 31 reads, based on the ID information, the information of the person renting the game machine 1 which is prestored in the storage unit 23. Based on the read information, the rental fee, and the ID information of the game machine 1, the automatic bill issuing unit 31 automatically issues a bill in a predetermined mode, and may print it out by using the printer 32.

According to the third embodiment, the rental fee of the game machine 1 is automatically detected, and the bill is automatically issued. This considerably saves the staff the trouble of collecting the rental fee, thereby further increasing the profit of renting the game machine 1.

A fourth embodiment is described below. In the fourth embodiment, an automatic-bill-deduction processing unit 34, indicated by the two-dot-chain block shown in FIG. 3, is provided for the configuration of the third embodiment. The same elements as those of the third embodiment are designated with like reference numerals, and an explanation thereof will thus be omitted.

The automatic-bill-deduction processing unit 34 unique to the fourth embodiment automatically performs processing for the automatic deduction of the rental fee from a banking system. For example, the automatic-bill-deduction processing unit 34 is provided with a control program for the process of automatically deducting a rental fee. Upon determining that the rental fee has been detected by the rental-fee detecting unit 30 of the third embodiment, the automatic-bill-deduction processing unit 34 receives the detected rental fee information and the associated ID information of the game machine 1, and reads, based on the ID information, the information about, for example, the account number of the banking system designated by the person renting the game machine 1 from the storage unit 23.

Then, by utilizing the rental fee information, the ID Information of the game machine 1, and the information of the person renting the game machine 1, the automatic-bill-deduction processing unit 34 automatically performs processing for deducting the rental fee from the banking system according to the control program for the process of the automatic deduction of the rental fee.

According to the fourth embodiment, the automatic-bill-deduction processing unit 34 is provided, thereby automatically executing processing for deducting a rental fee from a banking system. Thus, the processing for the whole series of the rental fee collection from the detection of the number of game plays of the game machine 1 to the process for the automatic deduction of the rental fee can almost be automated. This considerably reduces the personnel expenses for the collection of the rental fee for the game machine 1, thereby further increasing the profit of renting the game machine 1.

The present invention is not restricted to the foregoing embodiments, and various other embodiments may be made. For example, in the foregoing embodiments, the situation-of-use information includes at least the coin-insertion detected number information of the coin-insertion detector 5, the switching-on information of each of the service SW 6 and the test SW 7, the count value information of the coin counter 8, and the power on/off information. However, the situation-of-use information may include at least one of the following four types of information, such as the coin-insertion detected number information of the coin-insertion detector 5, the count value information of the coin counter 8, the power on/off information, and the switching-on information of at least one of the service SW 6 and the test SW 7, which are free switches. That is, it is not essential that the situation-of-use information include all of the four types of information.

In the above-described embodiments, the time for the whole day is divided into a plurality of time slots, and the situation-of-use information of all the time slots is incorporated. However, only a predetermined monitoring period during one day, such as from 10 a.m. of one day to 2 a.m. of the following day, may be divided into a plurality of time slots, and the situation-of-use information of the game machine 1 only during the monitoring period may be incorporated.

Additionally, in the aforementioned embodiments, the one day period is divided into a plurality of time slots, as discussed above, and the number of times the power is switched on/off for each time slot is detected as the power on/off information. Alternatively, by utilizing the timepiece mechanism 15, the duration for which the power is on and the duration for which the power is off may be detected. Then, the power-on information may be associated with the abovementioned duration for which the power is on (timepiece information), and the power-off information may be associated with the duration for which the power is off (timepiece information). Such power on/off information (i.e., power on/off information associated with the timepiece information) may be stored in the data storage device 17, and may be sent by radio to the central monitoring apparatus 3.

Moreover, information other than the power on/off information may be stored in the data storage device 17 by associating it with the timepiece information of the timepiece mechanism 15, as stated above, and the situation-of-use information associated with the timepiece information may be sent by radio to the central monitoring apparatus 3. More specifically, for example, the duration for which the service SW 6 or the test SW 7, which is a free switch, is turned on, is detected in detail. The detected switching-on duration may be stored in the data storage device 17 as the switching-on information (situation-of-use information) associated with the timepiece information, as stated above. Similarly, the duration for which the coin counter 8 increments may be detected, and the detected incremented duration may be stored in the data storage device 17 as the count information (situation-of-use information) of the coin counter 8 associated with the timepiece information. Or, the duration for which the insertion of a coin is detected by the coin-insertion detector 5 may be detected in detail, and may be stored in the data storage device 17 as the coin-insertion detected information (situation-of-use information) associated with the timepiece information. The stored situation-of-use information may be sent by radio to the central monitoring apparatus 3.

In the aforementioned embodiments, the one day period is divided into a plurality of time slots. Then, the amount by which the coin-insertion detected number of the coin-insertion detector 5 has been increased is incorporated as the coin-insertion detected number information of the coin-insertion detector 5, and the amount by which the count value of the coin counter 8 has been increased is incorporated as the count value information. However, the coin-insertion detected number information of the coin-insertion detector 5 and the count value information of the coin counter 8 may be used only for detecting the rental fee. In this case, the coin-insertion detected number of the coin-insertion detector 5 and the count value of the coin counter 8 may be incorporated at preset intervals (for example, every month if the rental fee is charged every month, or every other month if the rental fee is charged every other month). Then, the amounts by which the coin-insertion detected number and the count value have been increased during the above-described interval may be incorporated as the situation-of-use information.

Although in the foregoing embodiments the timepiece mechanism 15 is disposed within the monitoring control unit 2, it may be provided outside the monitoring control unit 2. Alternatively, if a timepiece mechanism is disposed within the game-machine control unit 9, it may be substituted for the above-described timepiece mechanism 15. In this case, the timepiece mechanism within the game-machine control unit 9 also serves the function of the timepiece mechanism 15, thereby making it possible to eliminate the provision of the timepiece mechanism 15 within the monitoring control unit 2.

In the above-described embodiments, two types of free switches, such as the service SW 6 and the test SW 7, are provided for the game machine 1. However, one free switch, which serves both as the service SW 6 and the test SW 7, may be provided.

In the aforementioned embodiments, a wireless communication system for cellular telephones is employed for sending the situation-of-use information from each game machine 1 to the central monitoring apparatus 3. However, wire communication may be used for sending the situation-of-use information from each game machine 1 to the central monitoring apparatus 3. Alternatively, a wireless communication system other than that for cellular telephones may be employed for transmitting the situation-of-use information from each game machine 1 to the central monitoring apparatus 3. Accordingly, the communication system for sending and receiving signals between each game machine 1 and the central monitoring apparatus 3 is not limited, and may be suitably selected according to the various conditions, such as the installation environment of the game machine 1.

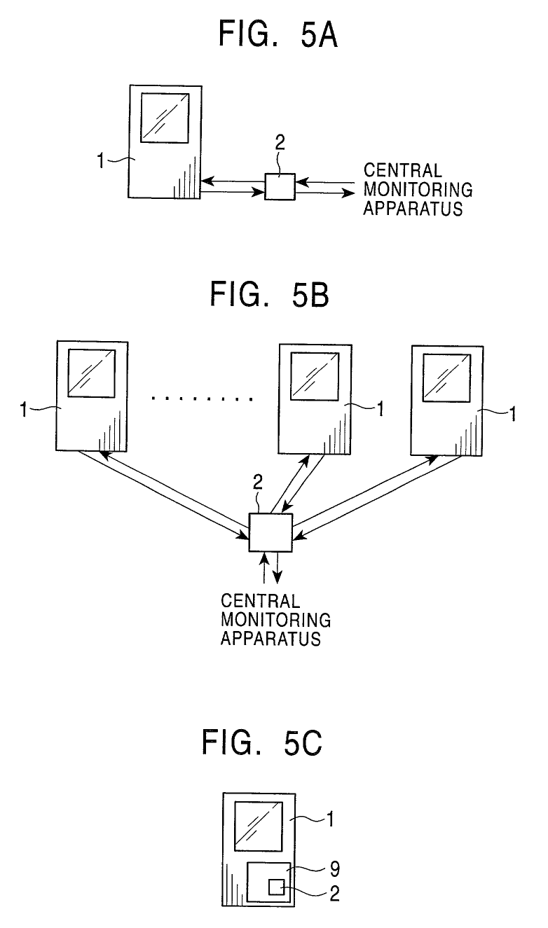

Although in the foregoing embodiments the monitoring control unit 2 is built into each game machine 1, it may be externally attached to the game machine 1, as shown in FIG. 5A. In this case, either wire communication or wireless communication may be employed for the signal communication between the game machine 1 and the monitoring control unit 2 and the signal communication from the monitoring control unit 2 to the central monitoring apparatus 3. When a wire-telephone communication system or a cellular-telephone communication system is employed for sending the signal from the monitoring control unit 2 to the central monitoring apparatus 3, a telephone function unit is disposed within the monitoring control unit 2. When a wireless communication system is employed for performing communication between the game machine 1 and the monitoring control unit 2, a communication device for performing wireless communication is disposed within the monitoring control unit 2.

Although in the above-described embodiments the monitoring control unit 2 is disposed in each of the game machines 1, it may also be provided for a plurality of the game machines 1, as shown in FIG. 5B. In this case, the monitoring control unit 2 incorporates the situation-of-use information of the individual game machines 1, and sends it to the central monitoring apparatus 3. In this case, the situation-of-use information incorporating device 14, the controller 16, the data storage device 17, and the communication device 18 of the common monitoring control unit 2 also serve as the counterparts of each game machine 1. As stated above, either wire communication or wireless communication may be employed for connecting the signals between each game machine 1 and the monitoring control unit 2 and for connecting the signals from the monitoring control unit 2 to the central monitoring apparatus 3.

In the foregoing embodiments, the monitoring control unit 2 and the game-machine control unit 9 are separately provided. As shown in FIG. 5C, however, the monitoring control unit 2 may be disposed within the game-machine control unit 9. The situation-of-use information incorporating device 14, the controller 16, the data storage device 17, and the communication device 18 may be provided in the game-machine control unit 9 rather than being formed into a unit.

In the aforementioned embodiments, the present invention has been described in the context of a remote, central management system for the rented game machines 1 which are located in a plurality of places. In the present invention, however, the game machines 1 are not limited to rental game machines. For example, the present invention is applicable when a proprietor who runs a plurality of game centers centrally monitors the game machines located in the different game centers.

According to the present invention, the situation-of-use information of the individual game machines located in a plurality of places is sent by radio from each game machine to the common central monitoring apparatus. Accordingly, the situation-of-use information of each game machine can be centrally monitored by using the central monitoring apparatus.

With this arrangement, various advantages are offered. For example, the coin-insertion detected number information of the coin-insertion detector and the count value information of the coin counter are transmitted to the central monitoring apparatus as the situation-of-use information. Accordingly, the number of game plays of each game machine can be checked by using the central monitoring apparatus based on the coin-insertion detected number information of the coin-insertion detector and the count value information of the coin counter, with the result that the rental fee for the game machines can be determined and collected without the need for the sales staff to visit the game machines. This makes it possible to reduce travelling expenses for the sales staff to collect rental fees for the game machines, thereby increasing the profit of renting the game machines.

Additionally, the switching-on information of a free switch is sent to the central monitoring apparatus as the situation-of-use information. With this arrangement, the number of times the free switch is switched on can be detected by using the central monitoring apparatus, thereby detecting the illegal use of the game machine using the free switch. Then, a warning against the illegal use of the game machine can be issued, thereby preventing the illegal use of the game machine.

Moreover, the switching-on information of a free switch, the count value information of the coin counter, and the power on/off information are sent to the central monitoring apparatus as the situation-of-use information. With this arrangement, the running condition of the game machine can be detected by using the central monitoring apparatus. It is thus possible to give appropriate advice about the installation places and the environment setting of the game machines. This introduces a new aspect to the services for the game machines.

When wireless communication or a wireless communication network for cellular telephones is used for sending the situation-of-use information of each game machine to the central monitoring apparatus, the necessity of providing a cable for connecting each game machine to the central monitoring apparatus is obviated. For example, there are special circumstances for the game machines, for example, the installation places of the game machines located in a game center are frequency changed. Accordingly, when wire communication for the game machines is employed, it is required that game machines be connected and disconnected by cable every time they are moved. In contrast, as discussed above, wireless communication or a wireless communication system for cellular telephones is employed for sending the situation-of-use information of each game machine to the central monitoring apparatus, thereby solving the problem of connecting a cable to the game machines.

In the present invention in which a timepiece mechanism is provided to associate the power on/off information incorporated as the situation-of-use information of the game machine with time information of the time mechanism, the running conditions of the game machine can be monitored in greater detail.

In the present invention in which the timepiece mechanism is used for dividing the one day period into a plurality of predetermined time slots and for sending the situation-of-use information of the game machine for each time slot to the central monitoring apparatus, it is easy to monitor how the situation of the use of the game machine changes over time during one day. It is thus possible to easily obtain the more detailed information on the situation of the use of the game machine.

In particular, in the present invention in which the display device for displaying the situation-of-use information of the game machine for each time slot is provided for the central monitoring apparatus, it is possible to visually monitor how the situation of the use of the game machine changes over time during one day.

In the present invention in which the illegal use of the game machine is automatically detected based on the switching-on information of a free switch, the use of human resources is not necessary for detecting the illegal use of the game machine using a free switch, thereby preventing the illegal use of the game machine.

In the present invention in which the game machine is used as a rental game machine, and the rental fee for the game machine is detected based on the coin-insertion detected number information of the coin-insertion detector and the bill is automatically issued, the processing for the whole series of the collection of the rental fee from the detection of the number of game plays of the game machine to the issuing of the bill can be automatically performed. This considerably reduces the personnel expenses for collecting the rental fee, thereby further increasing the profit.

In the present invention in which the process for the automatic deduction of the above-described automatically detected rental fee from a banking system is automatically performed, the whole process for the collection of the rental fee of the game machines can almost be automated, thereby dramatically increasing the profit by renting the game machines.

In the present invention in which at least the situation-of-use information incorporating device, the data storage device, and the communication device are formed into a monitoring control unit, and a plurality of game machines are connected to the same monitoring control unit so that the situation-of-use information of each game machine is sent to the central monitoring apparatus via the common monitoring control unit, the number of monitoring control units is less than that required for providing the monitoring control unit for each game machine.

Although the above-described embodiments employ game machines utilizing coins as one example, it should be noted that the game machines, to which the present invention is applicable, are not limited to game machines utilizing coins. Namely, the present invention is applicable to any game machines that utilize a payment object used as compensation which is necessary for players to play (or start) the games. For example, the payment object includes money, such as a coin, a paper currency, a bank note, a bank bill, etc., and other objects, such as a token, a medal, etc.

What is claimed is:

1. A remote, central monitoring system for remotely and centrally monitoring a plurality of game machines, comprising:
a common central monitoring apparatus; and
a plurality of game machines located in a plurality of places, the plurality of game machines being remotely and centrally monitored by the common central monitoring apparatus,
wherein each of the plurality of game machines is capable of starting a game by inserting a payment object, and comprises:
a payment-object-insertion detector which detects insertion of a payment object,
a payment-object counter which counts the number of times insertion of a payment object is detected,
a free switch which starts the game without inserting a payment object,
a situation-of-use information incorporating device which incorporates predetermined situation-of-use information of each of the game machines, the situation-of-use information including at least one of payment-object-insertion detected number information of the payment-object-insertion detector of the game machine, count value information of the payment-object counter, switching-on information of the free switch, and power on/off information of each of the game machine,
a data storage device which stores the incorporated situation-of-use information, and
a communication device which sends the information stored in the data storage device to the common central monitoring apparatus.

2. The remote, central monitoring system of claim 1, wherein the communication device sends the information stored in the data storage device to the common central monitoring apparatus by wireless communication.

3. The remote, central monitoring system of claim 2, wherein the communication device sends the information stored in the data storage device to the common central monitoring apparatus by using a wireless communication system for cellular telephones.

4. The remote, central monitoring system of claim 1, wherein each of the game machines comprises a timepiece mechanism, and at least the power on/off information of each of the game machines is incorporated as the situation-of-use information of the game machine, and wherein at least the power on/off information among the situation-of-use information of the game machine is stored in the data storage device by being associated with time information of the timepiece mechanism and is sent to the common central monitoring apparatus.

5. The remote, central monitoring system of claim 1, wherein each of the game machines comprises a timepiece mechanism, a one day period is divided into a plurality of predetermined time slots by utilizing the timepiece mechanism, and a data writing unit which writes the situation-of-use information of the game machine for each of the time slots into the data storage device, and wherein the situation-of-use information of each of the game machines for each of the time slots is sent from each of the game machines to the common central monitoring apparatus.

6. The remote, central monitoring system of claim 5, wherein the common central monitoring apparatus comprises a display device which displays the situation of the use of the game machine based on the situation-of-use information for each of the time slots received from the game machine.

7. The remote, central monitoring system of claim 1, wherein at least the switching-on information of the free switch is sent from each of the game machines to the central monitoring apparatus as the situation-of-use information of the game machine, and wherein the common central monitoring apparatus comprises a warning issuing unit which issues a warning when the illegal use of the game machine based on the switching-on information of the free switch received from the game machine is detected.

8. The remote, central monitoring system of claim 1, wherein each of the game machines serves as a rental game machine, at least the payment-object-insertion detected number information of the payment-object-insertion detector is sent from each of the game machines to the common central monitoring apparatus as the situation-of-use information of the game machine, and wherein the central monitoring apparatus comprises:
a rental-fee detecting unit which automatically determines a rental fee of the game machine based on the received payment-object-insertion detected number information of the payment-object-insertion detector; and
an automatic bill issuing unit which automatically issues a bill for the rental fee.

9. The remote, central monitoring system of claim 8, wherein the common central monitoring apparatus comprises an automatic-bill-deduction processing unit which automatically performs processing for the automatic deduction of the rental fee of the game machine determined by the rental-fee detecting unit from a predetermined banking system.

10. The remote, central monitoring system of claim 1, wherein at least the situation-of-use information incorporating device, the data storage device, and the communication device are provided separately from each of bodies of the game machines as a monitoring control unit via a signal connection device, and serve as the situation-of-use information incorporating device, the data storage device, and the communication device provided for each of the game machines, respectively, and wherein the situation-of-use information of each of the game machines is sent to the common central monitoring apparatus via the monitoring control unit.
